(19) United States
(12) Patent Application Publication
(10) Pub. No.: US 2005/0124402 A1
(43) Pub. Date: Jun. 9, 2005

(54) Methods of playing games of chance and gaming devices with temporally limited or sequentially limited chances for enhanced payouts activated by winning outcomes

(76) Inventor: Randy Miller, Las Vegas, NV (US)

Correspondence Address: Daniel P. Burke;GALGANO & BURKE, Suite 135, 300 Rabro Drive, Hauppauge, NY, 11788, US

(21) Appl. No.: 10/728,351

(22) Filed: Dec. 4, 2003

(51) Int. Cl. A63F 13/00

(52) U.S. Cl. 463/13

(57) ABSTRACT

A video card game wherein if a player receives one of a preselected plurality of winning hands, a timer is activated which measures a predetermined time period. If the player attains a hand of equal value during the predetermined time period, then the player receives an enhanced payout.

The present invention is directed to gaming devices and methods of playing wagering games of chance wherein success during the play of one game qualifies a player for an enhanced payout. If the player obtains a winning outcome of similar value within a predetermined time, the player receives an enhanced payout.

### BACKGROUND OF THE INVENTION

Player's enjoy games of chance which are novel and which provide different ways of winning, particularly when wagering is involved and there is a chance for a very high payout.

The present invention is directed to novel gaming devices and methods of wagering games of chance which offer new opportunities for increased payouts.

### SUMMARY OF THE INVENTION

One aspect of the present invention is directed to a video poker game. If a player receives a winning hand, which is preferably one of a preselected plurality of winning hands, a timer is activated which measures a predetermined time period. If the player attains a hand of equal value to the “initiating” winning hand during the predetermined time period, then the player receives an enhanced payout. Another aspect of the present invention provides methods of playing a game of chance wherein one or more players win enhanced payouts if those players receive winning hands of equal value, for example, a ROYAL FLUSH within a predetermined time period.

These and other embodiments of the present invention are described below.

### BRIEF DESCRIPTION OF THE DRAWING

FIG. 1 is a screen display of a video poker game of one embodiment of the present invention.

FIG. 2 is a screen display of video poker game of an alternative embodiment of the present invention.

FIG. 3 is a screen display of a video poker game of a third embodiment of the present invention.

FIG. 4 is a screen display of a blackjack version of the present invention.

FIG. 5 illustrates a table version of the present invention.

### DETAILED DESCRIPTION

The various embodiments of the present invention provide gaming devices and methods for players wagering games of chance wherein a first successful outcome qualifies a player for an enhanced payout. The enhanced payout is obtained if the player receives either an identical hand or a hand of equal value, subject to the discretion of the manufacturer or gaming establishment, within a predetermined time period. The duration of the time period can be dependent upon the initial winning outcome and/or the amount of the enhanced payout. From the present invention, those skilled in the art will understand that the opportunity for an enhanced payout will encourage a player to continue playing even after receiving a winning payout. Some players may desire to stop playing a game after obtaining a winning payout. The present invention provides a player with an incentive to continue playing after receiving a winning payout.

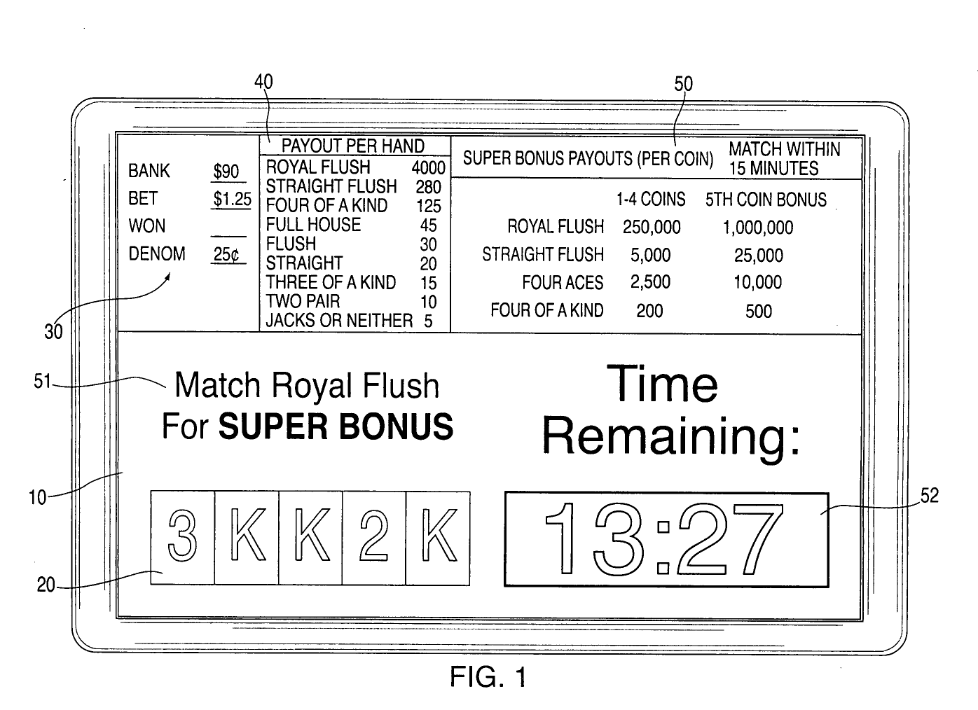

FIG. 1 illustrates a screen display of a video poker version of the present invention. This embodiment comprises a screen 10 comprising a five card display 20, a wagering display 30 which indicates how much credit the player has in his bank, the total amount of a present wager and the denomination fo the player's wager, as well as a payout schedule 40. Additionally, this embodiment of the present invention also comprises an enhanced payout table 50, an enhanced payout message 51 and a timer display 52. According to this embodiment of the present invention, a player can play video poker in a conventional fashion, determining the denomination of his wager and the number of coins wagered on each hand. Though not shown in FIG. 1, a player can be provided with an opportunity to draw additional cards in a known manner. If a player obtains a winning hand from a preselected plurality of winning hands which according to this embodiment include a ROYAL FLUSH, STRAIGHT FLUSH, FOUR ACES and FOUR OF A KIND, this “initiating” hand activates a timer. According to this embodiment of the present invention, a player is given 15 minutes to match the initiating winning hand. A player is provided with an indication of his opportunity to obtain an enhanced payout with instructions 51. Additionally, a timer display window 52 informs the player of the amount of time remaining for receiving the enhanced payout. While the illustrated timer counts down from 15 minutes, it is also within the scope of the present invention to have a timer which counts up to 15 minutes, or some other time period, or to have other indicia of the amount of time remaining, such as a timer which only flashes every minute or every three minutes. Alternatively, it is within the scope of the present invention to not provide a player with a discernible indication of the amount of time remaining and to only indicate when the time has expired. According to the embodiment of the present invention shown in FIG. 1, a player obtains a higher enhanced payout if the player wagers a certain amount, in this example a fifth coin.

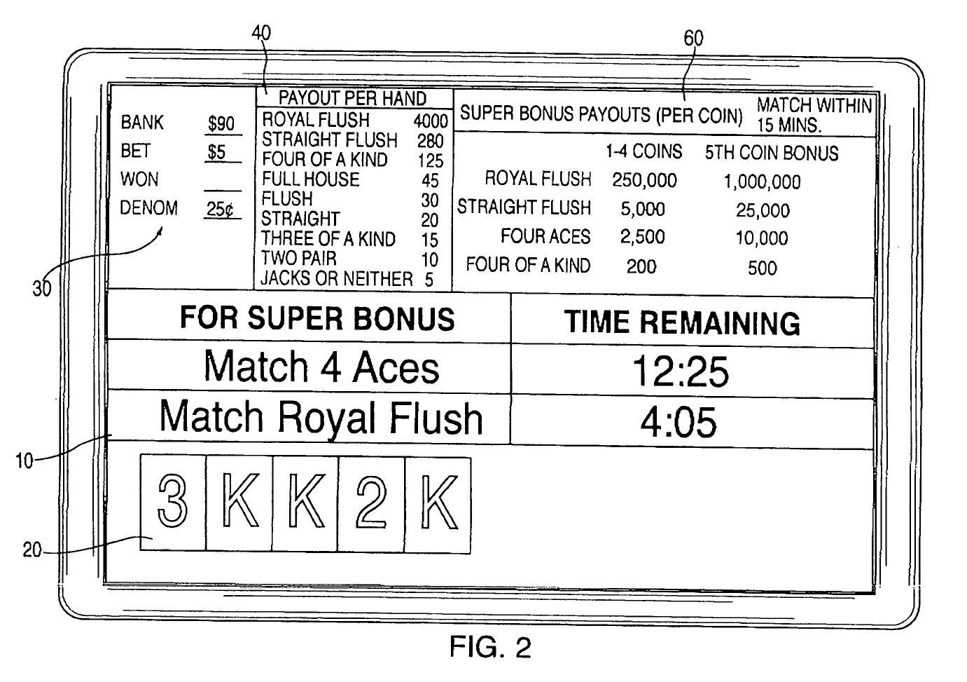

The embodiment illustrated in FIG. 2 is similar to that shown in FIG. 1, however, this embodiment illustrates another aspect of the present invention wherein this game provides multiple timers for multiple initiating winning hands. In the manner illustrated, a player has four minutes, five seconds remaining to win an enhanced bonus with a subsequent ROYAL FLUSH and 12 minutes, 25 seconds remaining to receive an enhanced payout by receiving FOUR ACES. According to this aspect of the present invention, a timer is initiated for each initiating winning hand. While FIG. 2 illustrates two timers being displayed on a display screen, the present invention can provide a greater number of timers for different initiating winning hands.

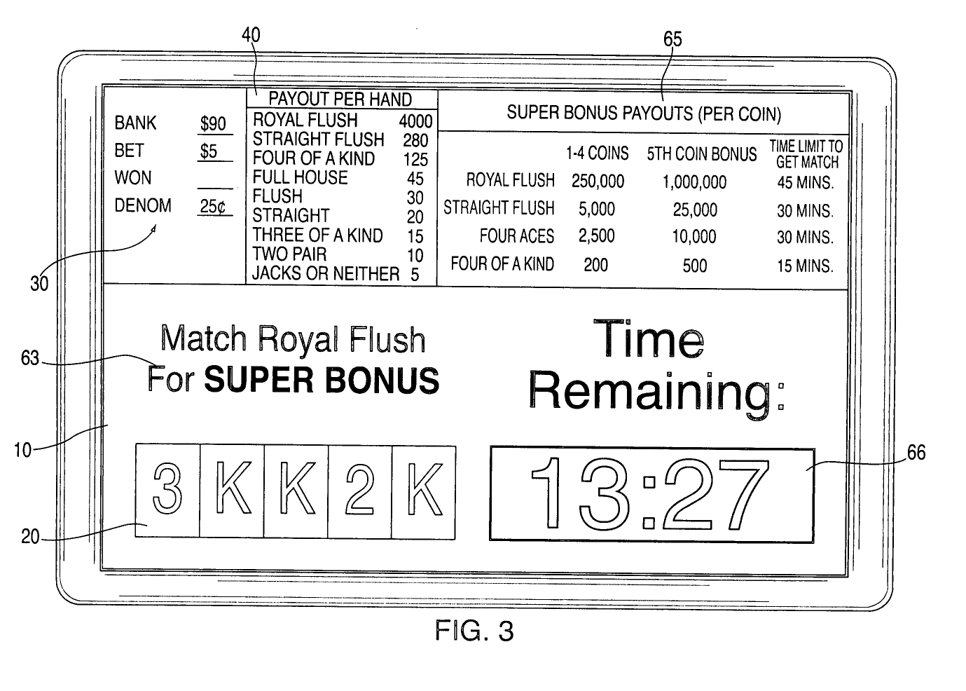

FIG. 3 illustrates an alternative embodiment of the present invention wherein the amount of time provided to a player after receiving an initiating winning hand is different depending upon the value of the initiating winning hand. According to this embodiment, a player is provided with 45 minutes to obtain a second ROYAL FLUSH, 30 minutes to obtain either a STRAIGHT FLUSH or FOUR ACES and 15 minutes to obtain FOUR OF A KIND. This aspect of the present invention is applicable to any of the embodiments disclosed herein. As noted above, it is also within the scope of the present invention to determine which hands qualify for enhanced payouts. While the illustrated embodiments list four types of poker hands which qualify a player for an enhanced payout, a greater or fewer number of hands or different hands can qualify a player for an enhanced payout. The opportunity for an enhance payout can also be dependent upon obtaining an identical hand with identical cards, can simply require an hand of equal value, for example, any type of a FOUR OF A KIND, or can be otherwise limited according to the desires of the manufacturer or gaming establishment.

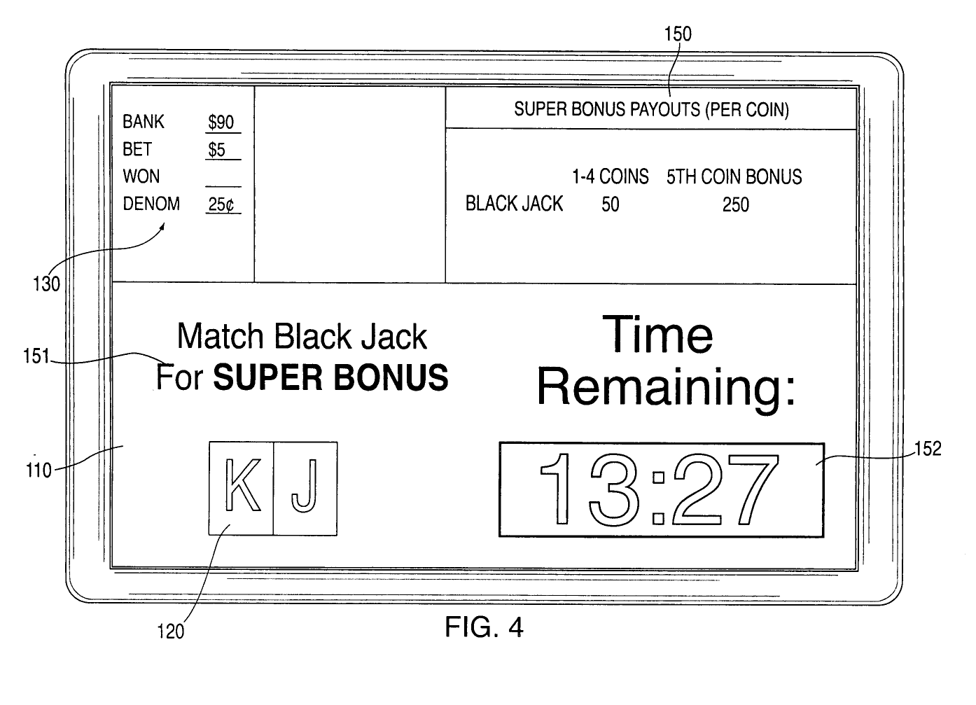

FIG. 4 illustrates another embodiment of the present invention in the form of a video blackjack game. According to this embodiment of the present invention, a player who has received a hand of blackjack is provided with a predetermine time period to qualify for an enhanced payout. Of course, it is also within the scope of the present invention to provide an enhanced payout in a video blackjack game if a player obtains a BLACKJACK, or other predetermined hand such as a six card hand without exceeding twenty-one, within a predetermined number of hands following the initiating winning hand.

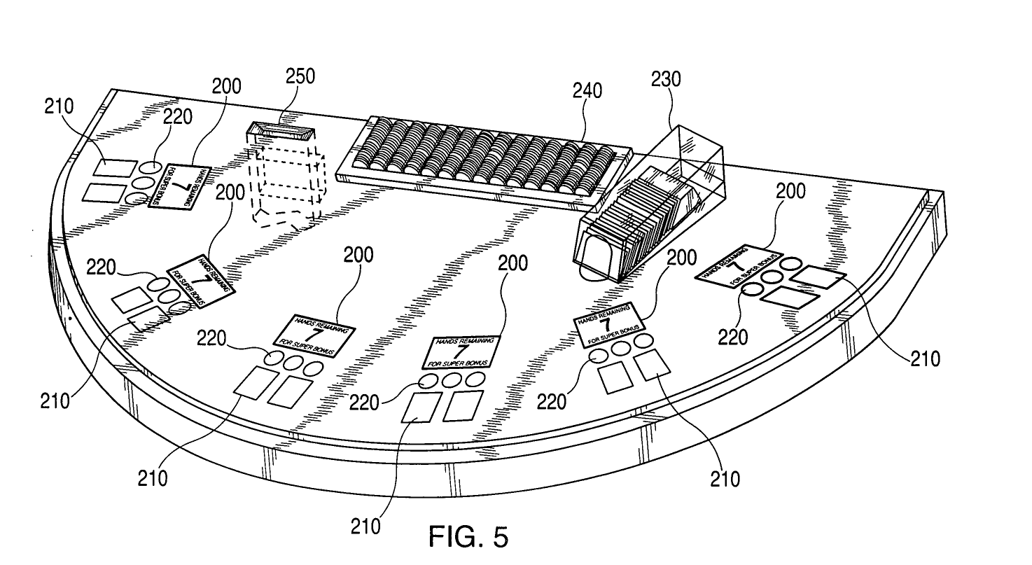

The various aspects of the present invention can also be enjoyed in a table version. FIG. 5 illustrates a table version of a blackjack game. This embodiment of the present invention comprises a table with six (6) player stations each comprising card areas 210, wager areas 220 and enhanced payout indicator window 200. Additionally, the table comprises a card shoe 230, a chip rack 240 and a discard chute 250. According to this embodiment of the present invention, if a player receives an initiating winning hand, then a display 200 at the player's station provides an indication of the time remaining for the player to receive an enhanced payout.

While the illustrated embodiments of the present invention have indicated a single hand shown on the video screens and the playing surface of the table shown in FIG. 5, it is also within the scope of the present invention to provide players with an opportunity to play more than one hand at a given time.

Another aspect of the present invention is directed to a method of conducting a video keno game wherein the player is provided with an opportunity to place a wager and play a game of video Keno. If the player obtains an initial winning keno combination, a timer is started. The player is provided with an enhanced payout if the player obtains a winning combination of equal value to the initial winning combination during the predetermined time period. With respect to keno, a game is considered of equal value if the player obtains the same number of winning numbers in both games. The duration of the predetermined time period can be dependent upon the number of winning numbers obtained by the player.

1. A method of conducting a video poker game comprising the steps of:
providing a player with an opportunity to place a wager and play a hand of video poker;
if the player obtains at least one preselected winning hand, starting a timer which runs for a predetermined time period; and
providing an enhanced payout if a hand of equal value to said preselected winning hand is obtained during said predetermined time period.

2. A method of conducting a video poker game according to claim 1 further comprising the step of providing discernible indications of said enhanced payout and said timer during at least part of said predetermined time period.

3. A method of conducting a video poker game according to claim 2 wherein discernible indicator is provided during the entire predetermined time period.

4. A method of conducting a video poker game according to claim 3 wherein said discernible indicator stops when a hand of equal value is obtained.

5. A method of conducting a video poker game according to claim 4 wherein said discernible indicator comprises a visual indicator.

6. A method of conducting a video poker game according to claim 3 wherein said discernible indicator comprises a visual indicator.

7. A method of conducting a video poker game according to claim 2 wherein said discernible indicator comprises a visual indicator.

8. A method of conducting a video poker game according to claim 1 wherein the timer can be activated by only one preselected winning hand of the preselected plurality of winning hands.

9. A method of conducting a video poker game according to claim 1 wherein the timer can be activated by more than one preselected winning hand of the preselected plurality of winning hands.

10. A method of conducting a video poker game according to claim 1 wherein a plurality of timers can be activated by a preselected plurality of winning hands.

11. A method of conducting a video poker game according to claim 1 wherein the duration of said predetermined time period is different for at least two different winning hands of different values.

12. A method of conducting a video blackjack game comprising the steps of:
providing a player with an opportunity to place a wager and play a hand of video blackjack;
if the player obtains at least one preselected winning hand, starting a timer which runs for a predetermined time period; and
providing an enhanced payout if a hand of equal value to said preselected winning hand is obtained during said predetermined time period.

13. A method of conducting a video blackjack game according to claim 12 further comprising the step of providing discernible indications of said enhanced payout and said timer during at least part of said predetermined time period.

14. A method of conducting a video blackjack game according to claim 13 wherein said discernible indicator comprises a visual indicator.

15. A method of conducting a video keno game comprising the steps of:
providing a player with an opportunity to place a wager and play a game of video keno;
if the player obtains an initial winning keno combination, starting a timer which runs for a predetermined time period; and
providing an enhanced payout if the player obtains a winning combination of equal value to said initial winning combination during said predetermined time period.

16. A video poker game comprising:
means for displaying indicia of cards for at least one poker hand;
a first payout display comprising a plurality of predetermined winning poker hands;
a second payout display comprising at least one enhanced payout which is payable when a predetermined second winning hand of equal value is displayed within a predetermined time period of the display of a first winning hand.

17. A video poker game according to claim 16 wherein said payout device provides payouts corresponding to said first payout table for one or more displayed winning hands.

18. A video poker game according to claim 16 wherein at least one enhanced payout is at least 25,000 times a player's wager on one hand.

19. A video poker game according to claim 16 wherein at least one enhanced payout is at least 100,000 times a player's wager on one hand.

20. A video poker game according to claim 16 wherein at least one enhanced payout is provided from a progressive jackpot.

21. A video poker game according to claim 16 wherein said second payout display also displays a timer which counts down the time remaining in the predetermined time period.

22. A video poker game according to claim 1 wherein said second payout display comprises at least four enhanced payouts within a predetermined number of hands following the display of a first winning hand.

23. A video poker game according to claim 22 wherein said second payout display comprises at least one enhanced payout for identical hands.

24. A video poker game according to claim 22 wherein at least one enhanced payout is at least 25,000 times a player's wager on one hand.

25. A video poker game according to claim 19 wherein at least one enhanced payout is at least 250,000 times a player's wager on one hand.

26. A video poker game according to claim 20 wherein at least one enhanced payout is at least 1,000,000 times a player's wager on one hand.
